(19) United States
(12) Patent Application Publication
(10) Pub. No.: US 2011/0302270 A1
(43) Pub. Date: Dec. 8, 2011

(54) MULTICAST DISTRIBUTION CONTROL SYSTEM

(75) Inventors: Hiraku KAWABE, Saitama (JP); Minoru TAKAYAMA, Yokohama (JP)

(73) Assignee: Hitachi, Ltd.

(21) Appl. No.: 13/019,676

(22) Filed: Feb. 2, 2011

(30) Foreign Application Priority Data
Jun. 3, 2010 (JP) 2010-128048

(51) Int. Cl. G06F 15/16

(52) U.S. Cl. 709/217

(57) ABSTRACT

Each of terminals transmits positional information indicating a current position of the terminal and a request for acquisition of multicast contents or receives the multicast content; an input accepting unit that accepts an input of the positional information and the request for acquisition; a display unit that displays the multicast content; and a terminal control unit that finds the positional information or causes the display unit to display the multicast content, and the contents distribution control server has: a server communication unit that receives the positional information and the request for acquisition or transmits the multicast content; a setting memory device that stores areas to which multicast contents can be transmitted, channel information for transmission of the multicast contents and area positional information indicating locations of the areas; and a server control unit that determines the positional information and the request for acquisition and causes the multicast content that permits viewing-listening on the basis of the channel information matching the area positional information.

### CLAIM OF PRIORITY

The present application claims priority from Japanese application serial no. JP2010-128048, filed on Jun. 3, 2010, the content of which is hereby incorporated by reference into this application.

### TECHNICAL FIELD

The present invention relates to a multicast distribution control system which distributes multicast contents by IP multicast communication.

### RELATED ART

According to a known IP multicast communication formula, the router nearest to a terminal operated by a viewer-listener receives a Join signal of the Internet Group Management Protocol (IGMP) defined by a multicast content viewing-listening request (Request For Comment (RFC)) issued by a client terminal. Then, an IP multicast network of a group of routers including that router can autonomously distribute the multicast content to the client terminal having issued the multicast content viewing-listening request via a multicast routing protocol. For this reason, it is difficult for the provider of the multicast contents to manage and control the area of multicast contents distribution, resulting in difficulty to architect business models of tolling for and localization of the distribution of multicast contents.

A number of methods have been devised to restrict the unlimited distribution of multicast contents such as what is described above. For instance, JP-A No. 2004-253968 discloses a method that realizes this objective by controlling routers or layer 2 switches on the distribution routes of multicast contents.

### SUMMARY OF THE INVENTION

However, the technique disclosed in JP-A No. 2004-253968 is difficult to apply to mobile terminals whose characteristic is mobility because it is intended for fixed viewing-listening terminals present on a local area network (LAN). Furthermore, a solution of the problem by controlling multicast routers or layer 2 switches has to be equipped with a specific control function for controlling distribution of all the multicast routers or layer 2 switches on the distribution route of multicast contents. Therefore, in the present state of art where no unified specifications are in effect regarding the distribution of multicast contents, a problem is eventually imposed that unrealistic system design of, for instance, making all the multicast routers or the layer 2 switches uniform to those of a specific vendor.

The present invention, attempted in view of this problem, is intended to provide a multicast distribution control system capable of appropriately distributing multicast contents without requiring distribution control on such communication equipment as multicast routers or layer 2 switches.

With a view to addressing the problem noted above and achieving the objective, the invention provides a multicast distribution control system for controlling distribution of multicast contents to terminals, wherein each of the terminals is a mobile terminal having: a terminal communication unit that transmits, to a contents distribution control server for controlling distribution of multicast contents, positional information indicating a current position of the terminal and a request for acquisition of the multicast content or receives, from the contents distribution control server, the multicast content; an input accepting unit that accepts an input of the positional information and the request for acquisition from a user of the terminal; a display unit that displays the multicast content; and a terminal control unit that finds the positional information or causes the display unit to display the multicast content, and the contents distribution control server has: a server communication unit that receives, from the terminal, the positional information and the request for acquisition or transmits, to the terminal, the multicast content; a setting memory device that stores, matched with each other, areas to which multicast contents can be transmitted, channel information for transmission of the multicast contents and area positional information indicating locations of the areas; and a server control unit that determines, when the server communication unit has received, from the terminal, the positional information and the request for acquisition, determines whether not the received positional information is contained in the area positional information and, when it is determined that the positional information is contained in the area positional information, causes the multicast content that permits viewing-listening by the terminal in the area to be transmitted to the server communication unit on the basis of the channel information matching the area positional information.

According to the invention, multicast contents can be appropriately distributed without requiring distribution control on such communication equipment as multicast routers or layer 2 switches.

### BRIEF DESCRIPTION OF THE DRAWINGS

FIG. 1 shows the overall configuration of a multicast distribution control system pertaining to an exemplary embodiment of the invention;

FIG. 2 shows an example of information held by a destination setting database illustrated in FIG. 1;

FIG. 3 shows an example of multicast contents stored in a memory unit of the contents distribution server;

FIG. 4 shows an example of address list prepared by a contents distribution control server;

FIG. 5 shows an example of program schedule distributed to a mobile terminal for which a request for acquisition of a program schedule has been made by the contents distribution control server;

FIG. 6 is a sequence chart showing the sequence of processing when the multicast distribution control system distributes a multicast content to a mobile terminal; and

FIG. 7 is a sequence chart showing the sequence of processing after the multicast distribution control system has distributed a multicast content to the mobile terminal.

### EXEMPLARY EMBODIMENT OF THE INVENTION

A multicast distribution control system, which is an exemplary embodiment of the present invention, will be described in detail below with reference to the accompanying drawings.

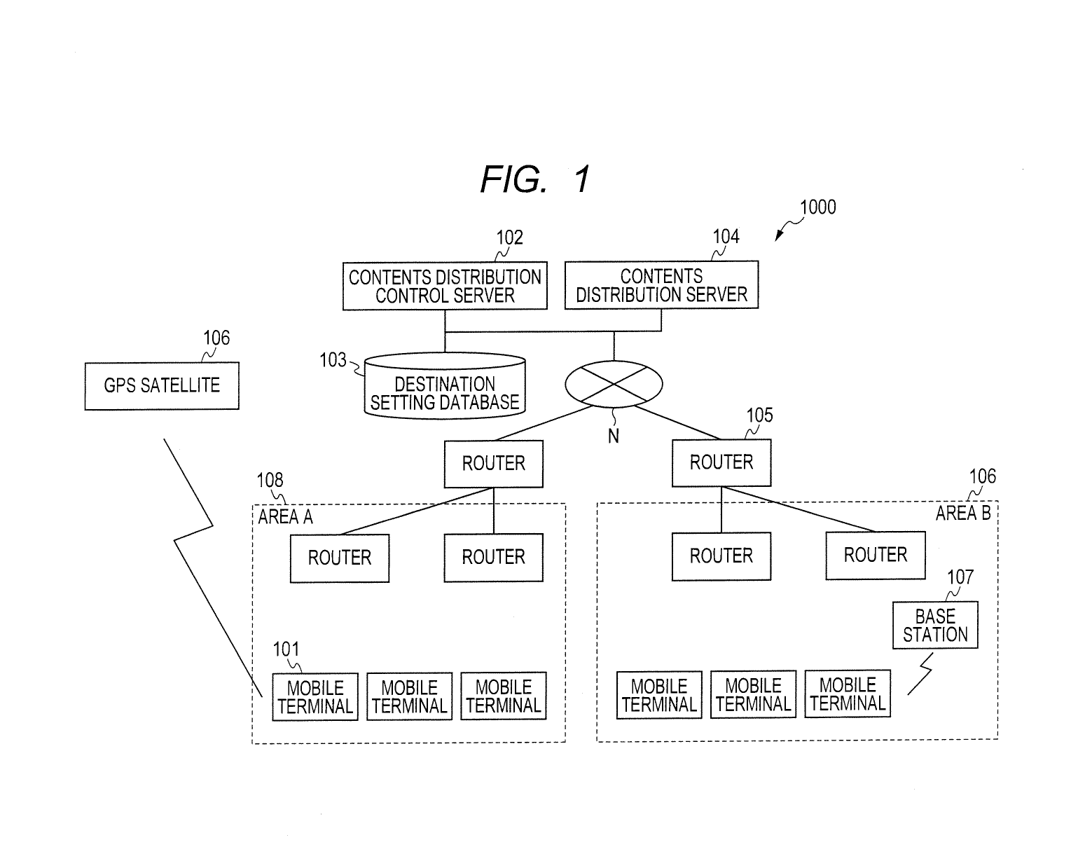

FIG. 1 shows the overall configuration of a multicast distribution control system 1000 pertaining to this exemplary embodiment. The multicast distribution control system 1000 includes mobile terminals 101 present in specific positions, a contents distribution control server 102 that determines whether or not it is permissible to distribute multicast contents to the mobile terminals 101, a destination setting database 103 that holds the setting of combinations of multiple multicast IP addresses and distribution areas of those addresses matched with each other, a contents distribution server 104 that accumulates multicast contents and sends out multicast contents at a viewing-listening request from any of the mobile terminals 101, routers 105 that distributes multicast contents to the mobile terminals 101, a communication network N for connecting these devices, a Global Positioning System (GPS) satellite 106 for determination by the mobile terminals 101 of their own positions, and a base station 107 that determines its own position if any mobile terminal 101 has no GPS function or if the position of current presence makes positioning by GPS temporarily impossible. Incidentally, the network N is an ordinary communication line network such as the Internet or a wide area network (WAN).

FIG. 1 shows a state in which the mobile terminals 101 are scattered in an area A 108 and an area B 109. Each area can be divided into any sub-areas, and a plurality of or a set of separate distribution areas can be set for each multicast IP address.

Though not shown in FIG. 1 in particular, each of the devices including the mobile terminals 101, the contents distribution control server 102 and the contents distribution server 104 has a control section including an arithmetic unit for performing various modes of processing to be described afterwards such as a central processing unit (CPU), a communication unit including a communication interface such as a network interface card (NIC), and a memory device (memory medium), such as a hard disk drive (HDD), for storing multicast contents and a program schedule setting forth the schedule of distributing the multicast contents, and various other information needed for distribution of multicast contents to the mobile terminals 101.

Each of the mobile terminal 101 has an input accepting unit including an input device, such as buttons, for accepting requests from users for a program schedule (to be described afterwards) and operations for viewing-listening of multicast contents and a display unit including a display device, such as a liquid crystal panel, for displaying the program schedule (to be described afterwards) and multicast contents among others. Although the following description presupposes that the terminals to which multicast contents are distributed are mobile terminals, they may be various other shiftable terminals or devices such as laptop personal computers (PCs) or car navigation systems.

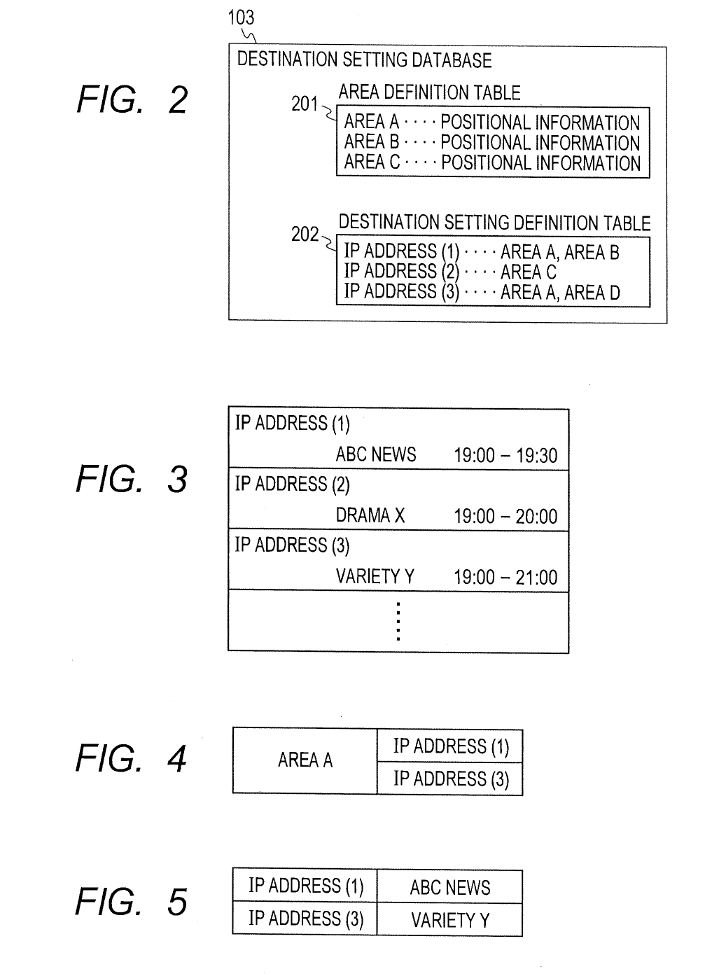

FIG. 2 shows an example of information held by the destination setting database 103 illustrated in FIG. 1. As shown in FIG. 2, the destination setting database 103 has an area definition table 201 in which positional information (e.g. coordinates indicating the latitude, longitude and altitude) representing geographical points identified by GPS and unit areas to which the distribution of multicast contents is destined are set matched with each other and a destination definition table 202 in which multicast IP addresses and areas to which multicast contents can be distributed according to those multicast IP addresses are set matched with each other.

The contents distribution control server 102, when it receives from the mobile terminal 101 a request for presentation of the program schedule to be executed ahead of the viewing-listening of multicast contents, prepares, on the basis of the destination definition table 202, a list of multicast IP addresses to which distribution is possible in the area matching the notified positional information (address list) and transmits the prepared address list to the mobile terminal 101. A specific example of this address list will be described afterwards.

FIG. 3 shows an example of multicast contents stored in the memory device of the contents distribution server 104. As shown in FIG. 3, the memory device of the contents distribution server 104 stores multiple sets of metadata in which multicast IP addresses, multicast contents to be distributed to mobile terminals 101 and distribution information including the time zones in which the multicast contents are to be distributed are matched with each other.

The example shown in FIG. 3 reveals that a program “ABC News” is distributed to a multicast IP address (1) (channel (1)) in a time zone “19:00-19:30”, a program “Drama X” is distributed to a multicast IP address (2) (channel (2)) in a time zone “19:00-20:00”, and a program “Variety Y” is distributed to a multicast IP address (3) (channel (3)) in a time zone “19:00-21:00”.

FIG. 4 shows an example of address list prepared by the contents distribution control server 102 in a mode of processing to be described afterwards. As shown in FIG. 4, the control unit of the contents distribution control server 102, when it has received, from a mobile terminal 101 located in a certain area (e.g. the area A), a request for acquisition of the program schedule including positional information (e.g. coordinate information indicating the latitude, longitude and altitude) representing the current location of that mobile terminal 101, accesses the area definition table 201 of the destination setting database 103 and specifies the area (e.g. the area A) represented by the received positional information.

Then, the control unit of the contents distribution control server 102 accesses the destination definition table 202 of the destination setting database 103, specifies the multicast IP addresses to which multicast contents distributable to mobile terminals 101 located in the specified area (e.g. the area A) are to be distributed, and prepares an address list in which the specified multicast IP addresses and the earlier specified areas are matched with each other.

The example shown in FIG. 4 reveals that, when the control unit of the contents distribution control server 102 has received, from a mobile terminal 101 located in the area A, positional information on the area A as the current location of the mobile terminal 101, it references the destination definition table 202 shown in FIG. 2, specifies the multicast IP address (1) and the multicast IP address (3), and prepares an address list in which these specified multicast IP addresses and the area to which multicast contents are to be distributed (the area A) are matched with each other.

FIG. 5 shows an example of program schedule distributed to a mobile terminal 101 for which a request for acquisition of a program schedule has been made by the contents distribution control server 102. As shown in FIG. 5, in the program schedule distributed to the mobile terminal 101, multicast IP addresses where viewing-listening is possible in the area in which the mobile terminal 101 is located and multicast contents to be distributed according to those multicast IP addresses are matched with each other.

The example shown in FIG. 5 reveals that the control unit of the contents distribution control server 102 references the multicast contents shown in FIG. 3 and the address list shown in FIG. 4 and, using the multicast IP address as the key, prepares a program schedule to distribute a multicast content “ABC News” to the multicast IP address (1) and a multicast content “Variety Y” to the multicast IP address (3) as the schedule of programs to be distributed to the mobile terminal 101 located in the area A. Now, the sequence of processing to distribute multicast contents carried out in the multicast distribution control system 1000 will be described.

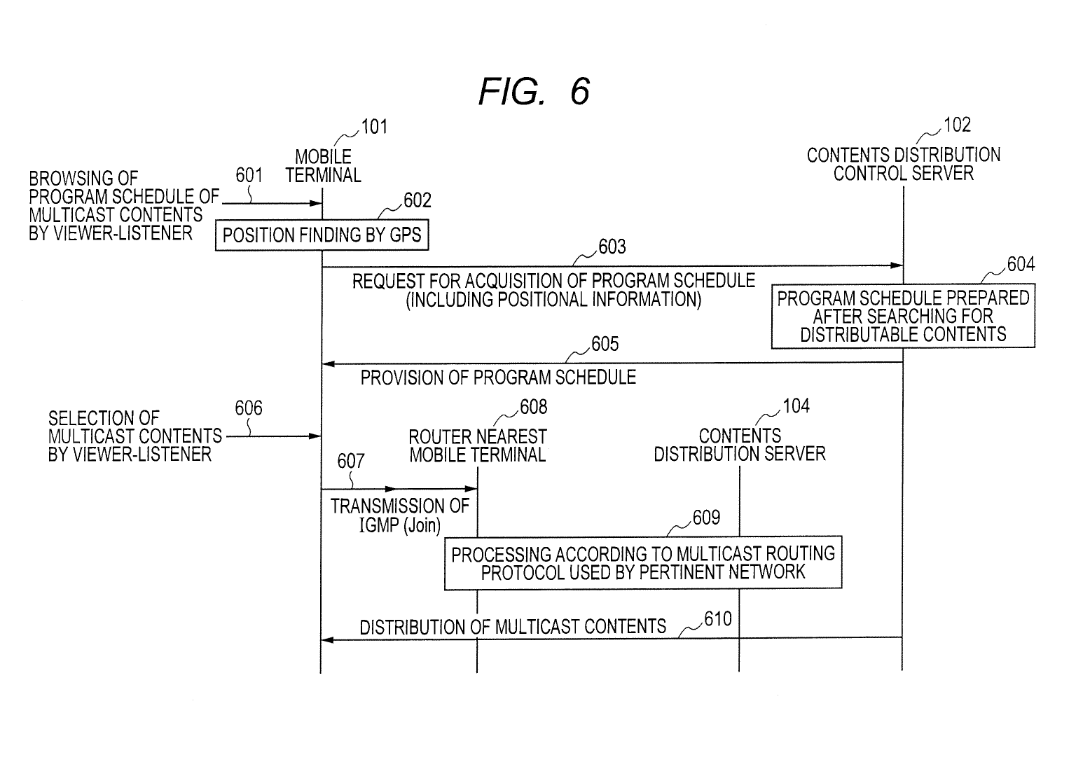

FIG. 6 is a sequence chart showing the sequence of processing when the multicast distribution control system 1000 distributes multicast contents to a mobile terminal 101. FIG. 6 shows the sequence of processing along the time axis until a viewer-listener owning the mobile terminal 101 selects a multicast content and the distribution of the multicast content is started.

In the sequence chart shown in FIG. 6, when a viewer-listener staying in a certain area (e.g. the area A) manipulates his or her mobile terminal 101 and the control unit of the mobile terminal 101 outputs a signal to notify of the start of an operation to browse the program schedule of the multicast contents to be provided by multicast distribution, the processing in this embodiment of the invention is started (step S601).

Then the control unit of the mobile terminal 101, prior to the acquisition of the program schedule, finds positional information on itself by either communicating with the GPS satellite 106 or communicating with the base station 107 (step S602). These ways of position finding are supposed to follow one or another of various known techniques.

Then, the control unit of the mobile terminal 101 requests the contents distribution control server 102 for acquisition of the program schedule of multicast contents available for multicast distribution including positional information (step S603).

The control unit of the contents distribution control server 102 references the positional information received from the mobile terminal 101, prepares an address list as shown in FIG. 4, references that address list and multicast contents as shown in FIG. 3, prepares a program schedule as shown in FIG. 5 with the multicast IP address as the key (step S604), and transmits the program schedule to the mobile terminal 101 (step S605).

After that, the mobile terminal 101 receives the program schedule from the contents distribution control server 102, and the viewer-listener selects a real time multicast content out of the list of multicast contents contained in that program schedule (step S606).

Then, the viewer-listener manipulates his or her mobile terminal 101, and the control unit of the mobile terminal 101 sends out to the nearest router 608 a request for participation in viewing-listening (a Join signal of the Internet Group Management Protocol (IGMP)) regarding the multicast IP address matching the multicast content selected by the viewer-listener (step S607).

The router 608 performs, in accordance with the prescribed formula of multicast routing used by the pertinent network N, processing required for routing to have the multicast content stored in the contents distribution server 104 distributed to the mobile terminal 101 (steps S608 and S609) and, after that, the contents distribution server 104 distributes the requested multicast content to the mobile terminal 101 (step S610). The specific method of this processing from step S608 through step S610 is supposed to conform to what is defined by RFC.

After completion of processing at this step S610, the distribution of multicast contents to the mobile terminal 101 is started. Now, processing performed after the distribution of multicast contents to the mobile terminal 101 will be described.

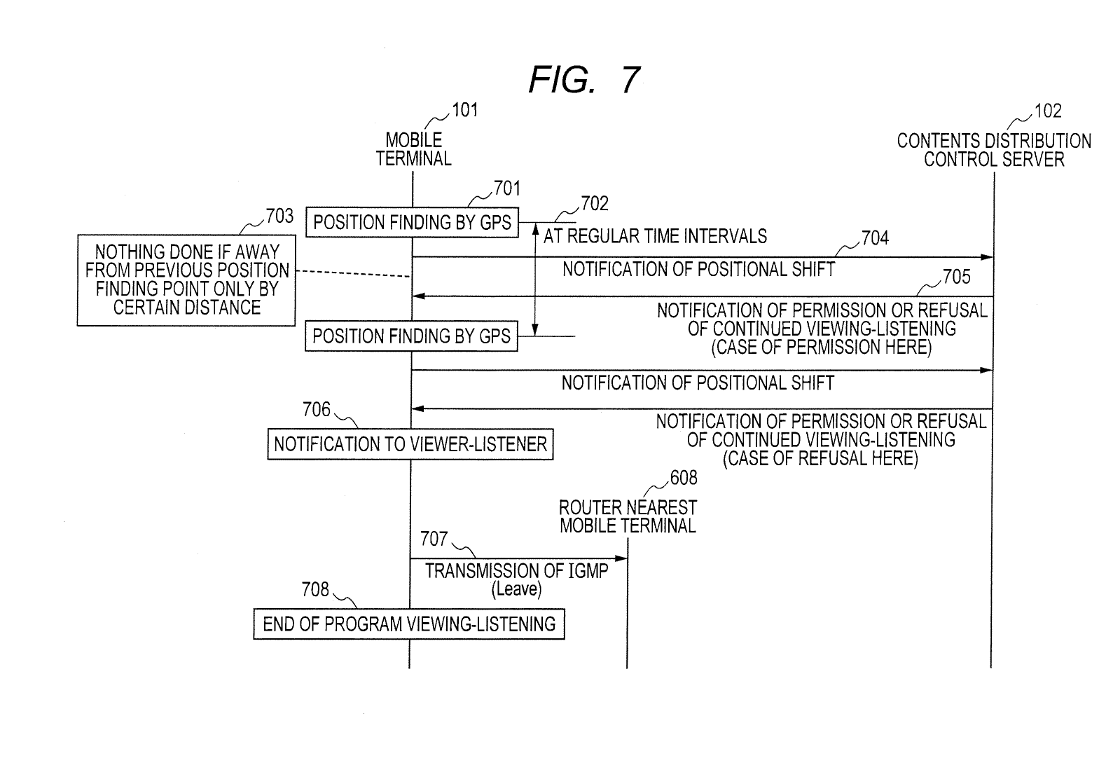

FIG. 7 is a sequence chart showing the sequence of processing after the multicast distribution control system 1000 has distributed the multicast content to the mobile terminal 101. FIG. 7 shows along the time axis the sequence of processing that takes place, when the viewer-listener holding the mobile terminal 101 has moved, mainly to determine whether or not continued viewing-listening of the distributed multicast contents is permissible.

In the sequence chart shown in FIG. 7, the control unit of the mobile terminal 101 finds its own position at regular intervals of time (steps S701 and S702), and notifies the contents distribution control server 102 of positional information and the currently received multicast IP address (step S704). Here, the control unit of the mobile terminal 101 determines whether or not the distance between the position found in the nearest past and that found on the previous occasion has reached a prescribed distance (e.g. a distance within the area A) and, if it determines that the prescribed distance has not been reached, no notification is given to the contents distribution control server 102 (step S703). Incidentally, these actions including position finding and notification performed by the mobile terminal 101 are supposed to be accomplished, for instance, by applications for use in the viewing-listening of multicast contents installed in the mobile terminal 101.

Matching of positional information on the mobile terminal 101 and the multicast IP address currently receiving information in this way and notifying the contents distribution control server 102 of the matches by the control unit of the mobile terminal 101 makes mounting possible without having the contents distribution control server 102 hold the states of individual mobile terminals, i.e., in a stateless arrangement.

Then the contents distribution control server 102, having received the positional information and the multicast IP address from the mobile terminal 101, checks the received positional information and multicast IP address with the destination definition table 202, determines whether or not the mobile terminal 101 remains permitted at the point of time as the destination of distribution of the pertinent multicast content, and returns the result (permission or refusal) (step S705).

Then, if the control unit of the mobile terminal 101 has received, from the contents distribution control server 102, a response that it can continue to receive distribution of the multicast content (permission), the mobile terminal 101 performs no particular processing and the viewer-listener continues to view and listen to the multicast content.

On the other hand, if the control unit of the mobile terminal 101 has received, from the contents distribution control server 102, a response that the multicast contents will not continue to be distributed (refusal), the mobile terminal 101 notifies the viewer-listener of his or her presence on a boundary of the distribution-permitted area (step S706).

When the viewer-listener has shifted out of the distribution-permitted area, the mobile terminal 101 transmits a signal of notifying deviation from the multicast IP address of the reception until then (an RFC-defined Leave signal of IGMP) to the router 608 nearest to the mobile terminal 101 (step S707), and the distribution of the multicast content to the mobile terminal 101 ends (step S708). With the ending of processing at this step S708, the whole processing in this embodiment of the invention is completed.

Thus, in the multicast distribution control system 1000 which controls the distribution of multicast contents to the mobile terminals 101, the mobile terminals 101 are shiftable terminals, wherein the communication unit (on the terminal side) transmits, to the contents distribution control server 102 which controls the distribution of multicast contents, positional information indicating the current location of the mobile terminal 101 and a request for acquisition of a multicast content, or receives, from the contents distribution server 104, a multicast content, the input accepting unit accepts inputting of positional information and a request for acquisition from the user of the mobile terminal 101, the display unit displays the multicast content, the control unit (on the terminal side) finds the position of the positional information or causes the multicast content to be displayed on the display unit, and in the contents distribution control server 102, the communication unit (on the server side) receives, from the mobile terminal 101, positional information and a request for acquisition, or transmits a multicast content to the mobile terminal 101, the destination setting database 103 stores, matched with one another, areas to which multicast contents can be transmitted, channel information for transmission of the multicast contents and area positional information indicating the location of the area information, the control unit (on the server side), when the communication unit (on the server side) has received, from the mobile terminal 101, positional information and a request for acquisition, determines whether or not the received positional information is contained in the area positional information and, if it determines that the positional information is contained in the area positional information, causes the multicast content that permits viewing-listening by the mobile terminal 101 in the area to be transmitted to the communication unit (on the server side) on the basis of channel information matching the area positional information, with the result that the multicast contents can be appropriately distributed without requiring distribution control on such communication equipment as multicast routers or layer 2 switches.

For instance, it is possible that a communication service provider commissioned by a multicast contents distributor to distribute multicast contents architects a multicast distribution control server and appropriately distributes multicast contents merely by controlling mobile terminals produced by a mobile terminal manufacturer, who can be requested by the communication service provider to provide required functions (or an application on mobile terminals for viewing-listening of multicast contents).

Or where a mobile terminal provides an application programming interface (API) for position finding to a developer of an application operating on that mobile terminal, multicast contents can be distributed by merely developing a multicast contents distribution control server to be owned and managed by the communication service provider and the matching application to be operated on the mobile terminal, enabling the required development to be accomplished with only a modest investment.

Further, regarding whether or not viewing-listening of multicast contents is permissible, the multicast contents providing side is enabled to limit it to a specific area and manage it there, making possible acceleration of the creation of new business models. Moreover, as a secondary effect, since it is possible to geographically limit the traffic of multicast IP addresses, prediction and control of the line band, or so-called traffic control, is possible.

The foregoing description of the exemplary embodiment of the present invention is not intended to limit the invention to the precise form disclosed, but can be materialized at the stage of practical application with its constituent elements modified without deviation from the essentials thereof. Various modifications can be worked out by appropriately combining the multiple constituent elements disclosed in the exemplary embodiment. For instance, a number of constituent elements can be deleted from all the constituent elements indicated in the exemplary embodiment. Furthermore, various constituent elements in other embodiments can as well be combined as appropriate.

As hitherto described, the multicast distribution control system according to the invention can be applied as means of encouraging creation of business models for commercial use of multicast contents distribution utilizing multicast communication to mobile terminals.

What is claimed is:

1. A multicast distribution control system for controlling distribution of multicast contents to terminals,
wherein each of the terminals is a mobile terminal having:
a terminal communication unit that transmits, to a contents distribution control server for controlling distribution of multicast contents, positional information indicating a current position of the terminal and a request for acquisition of the multicast content or receives, from the contents distribution control server, the multicast content;
an input accepting unit that accepts an input of the positional information and the request for acquisition from a user of the terminal;
a display unit that displays the multicast content; and
a terminal control unit that finds the positional information or causes the display unit to display the multicast content, and
the contents distribution control server has:
a server communication unit that receives, from the terminal, the positional information and the request for acquisition or transmits, to the terminal, the multicast content,
a setting memory device that stores, matched with each other, areas to which multicast contents can be transmitted, channel information for transmission of the multicast contents and area positional information indicating locations of the areas; and
a server control unit that determines, when the server communication unit has received, from the terminal, the positional information and the request for acquisition, determines whether or not the received positional information is contained in the area positional information and, when it is determined that the positional information is contained in the area positional information, causes the multicast content that permits viewing-listening by the terminal in the area to be transmitted to the server communication unit on the basis of the channel information matching the area positional information.

2. The multicast distribution control system according to claim 1,
wherein, in the terminal,
the terminal communication unit further transmits, to the contents distribution control server, a request for acquisition of a program schedule of the multicast contents or receives, from the contents distribution control server, the program schedule,
the input accepting unit further accepts designation of the multicast content to be contained in the program schedule,
the display unit further displays the program schedule, and
the terminal control unit causes the display unit to display the multicast content whose designation has been accepted by the input accepting unit, and
in the contents distribution control server,
the server communication unit further transmits the program schedule to the terminal, and
the server control unit further generates, if the positional information is determined to be contained in the area positional information, the program schedule of multicast contents that permit viewing-listening by the terminal positioned in the current location on the basis of the positional information, the area positional information and the channel information received from the terminal, and causes the generated program schedule to be transmitted to the server communication unit.

3. The multicast distribution control system according to claim 1,
wherein, in the terminal,
the control unit finds the positional information by communication by a Global Positioning System (GPS) or by communicating with a base station in wireless communication with the terminal according to a prescribed communication formula.

4. The multicast distribution control system according to claim 1,
wherein, in the terminal,
the terminal control unit finds, when the terminal communication unit has received the multicast content, the current position of the terminal at prescribed intervals, and causes positional information indicating the found current position of the terminal to be transmitted to the contents distribution control server, and
in the contents distribution control server,
the server control unit determines, when the server communication unit has received, from the terminal, positional information indicating the current position of the terminal, whether or not the terminal can continue to be permitted viewing-listening of the multicast contents in the current position thereof, and causes a result of determination to be transmitted to the server communication unit.

5. The multicast distribution control system according to claim 4,
wherein, in the contents distribution control server,
the server control unit causes, if it determines that the terminal cannot continue to be permitted viewing-listening of the multicast content in the current position thereof, the terminal to notify the server communication unit of impermissibility of continued viewing-listening of the multicast content as well as the transmission of the multicast content to be ended.
